(19) United States
(12) Patent Application Publication
(10) Pub. No.: US 2026/0309535 A1
(43) Pub. Date: Oct. 8, 2026

(54) METHOD FOR DETERMINING THE INNER DIAMETER OF A SURGE PIPE USING A FILL LEVEL MEASURING DEVICE

(71) Applicant: Endress+Hauser SE+Co. KG, Maulburg (DE)

(72) Inventors: Christian Übelin, Schopfheim (DE); Alexey Malinovskiy, Maulburg (DE)

(21) Appl. No.: 19/483,766

(22) PCT Filed: Apr. 2, 2024
(86) PCT No.: PCT/EP2024/058860

§ 371 Date: Nov. 12, 2025

(30) Foreign Application Priority Data
May 23, 2023 (DE) 10 2023 113 475.2

(51) Int. Cl. G01F 23/284

(52) U.S. Cl. CPC G01F 23/284

(57) ABSTRACT

A method for determining the pipe inner diameter of a surge pipe that extends for fill level measurement into a process space of the container in which the fill substance is located is based according to the FMCW principle on transmitting radar signals not only with a first center frequency, thus in a first frequency band, but, instead, supplementally with a second center frequency, wherein in both cases one and the same reference object is used for their reflection. In this way, according to the FMCW principle, two corresponding intermediate frequency signals, thus their frequencies, can be determined, such that the pipe inner diameter is calculated according to the invention based on the two center frequencies of the radar signals, and the two frequencies of the intermediate frequency signals.

The invention relates to a method for determining a pipe inner diameter of a surge pipe, which for measuring fill level of a fill substance located in a process space of a container extends into the process space or is placed alongside the container and is connected with the process space.

Applied in process automation technology for registering process parameters of interest are corresponding field device types. For the purpose of registering such process parameters, there are implemented in the field device types suitable measuring principles, with which the process parameters are registrable, process parameters such as fill level, flow, pressure, temperature, pH value, redox potential and conductivity. The most varied of such field device types are manufactured and sold by the “Endress+Hauser” group of firms.

For fill level measurement of fill substances in containers, contactless measuring methods have proven themselves, since they are robust and low-maintenance. Another advantage is their ability to measure fill level virtually continuously and with very high resolution. In this field of continuous fill level measurement, primarily radar based measuring methods are applied. An established measuring principle, in such case, is the FMCW principle.

The FMCW principle rests on continuous transmission of a high frequency radar signal. In such case, the frequency of the signal lies in a fixed frequency band around a standardized center frequency. According to standard, frequency bands in the 6 GHz band, the 26 GHz band, and the 79 GHz band are used. Characteristic for the FMCW method, in such case, is that the transmitted frequency is not constant, but, instead, changes periodically within the frequency band. The change can, depending on application, be linear with a sawtooth- or triangular shape or be a non-linear change, such as, for example, sinusoidal.

A special challenge is that the received signal received after reflection of the radar signal on the fill substance surface must be free of disturbance signals or at least the disturbance fractions known. Otherwise, faulty measured values can be generated, such that the ability of the fill level measuring device to function is degraded. A significant source of disturbance echo signal fractions are those arising not on the surface of the fill substance, but, instead, by reflection of the transmitted radar signal on disturbing bodies, such as stirrers or objects installed in the container. In the case of liquid fill substances, also wave formation can lead to a faulty fill level measurement.

A possibility for preventing, from the start, measurement errors caused by these problems in the case of liquid fill substances is the use of a surge pipe or bypass pipe. In this way, the fill substance surface is uniform within the surge pipe and the resulting beam path of the radar signal within the surge pipe is free of disturbing bodies. In such case, the surge pipe is placed approximately perpendicularly within the process space in the container. The surge pipe is structurally so vented that the fill level of the fill substance within the surge pipe agrees with the fill level within the remaining process space. In the case of a bypass pipe, such is placed alongside the container, wherein it also is connected with the process space in such a manner that the fill level in the bypass pipe equals the fill level in the process space.

In the case of use of a surge- or bypass pipe, the fill level measuring device is not, such as otherwise usual, arranged in such a manner that the antenna of the fill level measuring device is pointed directly into the process space where the fill substance is located. Rather, the fill level measuring device is so placed on the upper end of the pipe that the antenna of the fill level measuring device transmits the microwave signal into the surge pipe in the direction of the fill substance. Fill level measuring devices, which are arranged on surge pipes with round inner diameter, are, as a rule, calibrated for the pipe inner diameter of the intended surge pipe. For applications in the oil- and gas field, calibration is frequently for a reference inner diameter according to the standard, DIN EN ISO 6708, for example, DN 100.

A problem occurs when the pipe inner diameter of the surge pipe, on which the fill level measuring device is mounted in later use, does not exactly agree with the reference inner diameter of the calibration pipe. This frequent case is especially disadvantageous, in that already a small difference between the inner diameters causes a significant measurement error during fill level measurement and accordingly leads to a very inexact fill level measurement. The reason for this is that the signal propagation velocity of the radar signals in the surge pipe differs greatly from the free field-propagation velocity depending on pipe inner diameter.

Described in the publication DE 102016105419 A1 is a method, by means of which the pipe inner diameter can be determined based on radar based, fill level measuring devices. However, this method requires that the pipe inner diameter be at least roughly known. An object of the invention, therefore, is to provide a method, with which FMCW based fill level measuring devices, which are used on surge pipes or bypass pipes, can determine fill level exactly, even in the case of completely unknown pipe inner diameter. In such case, the terminology “surge pipe” within the scope of the invention equally encompasses bypass pipes.

The invention achieves the object by a method for determining a pipe inner diameter of a surge pipe, which for measuring fill level of a fill substance located in a process space of a container either extends into the process space or is mounted alongside the container and connected with the process space. The method comprises method steps as follows:
transmitting a first radar signal according to the FMCW principle with a first center frequency into the surge pipe and receiving a corresponding first received signal after reflection on a locationally fixed reference,
generating a first intermediate frequency signal according to the FMCW principle based on the first signals and ascertaining frequency of the first intermediate frequency signal,
transmitting a second radar signal according to the FMCW principle into the surge pipe with a second center frequency, which differs from the first center frequency, and receiving a corresponding, second received signal after reflection on the locationally fixed reference,
generating a second intermediate frequency signal according to the FMCW principle based on the second signals and ascertaining frequency of the second intermediate frequency signal,
ascertaining the pipe inner diameter based on at least
   the center frequencies of the radar signals, and
   the frequencies of the intermediate frequency signals.

Depending on situation, application and, depending on design of the surge pipe, serving as locationally fixed reference can be, for example, the surface of the fill substance, a lower end region of the surge pipe or the floor of the container.

Thus, based on the ascertained pipe inner diameter as well as based on the frequency of at least one of the intermediate frequency signals, the instantaneous signal propagation velocity in the surge pipe can be exactly ascertained, and, indeed, also without a rough previous knowledge of the pipe diameter. Based on the true signal propagation velocity, in turn, the exact fill level value can be determined.

Furthermore, the object of the invention is achieved by a fill level measuring device for performing the method described in at least one of the preceding variants. For this, the fill level measuring device comprises:
a signal production unit for FMCW based production of the radar signals,
a coupling element, by means of which the radar signals are coupleable into the surge pipe and the received signals are coupleable out of the surge pipe after their reflection,
a mixer unit for mixing the transmitted radar signals with the matching received signals, such that corresponding intermediate frequency signals are generated according to the FMCW principle,
an evaluation unit, which is designed,
   to ascertain the frequencies of the intermediate frequency signals,
   to determine the pipe inner diameter based on the center frequencies and the frequencies of the intermediate frequency signals, and,
   based on the ascertained pipe inner diameter as well as the frequency of at least one of the intermediate frequency signals, to determine the signal propagation velocity in the surge pipe, and, based thereon, the fill level.

The ascertained pipe inner diameter as well as the fill level value, and the underpinning intermediate frequency value, can be output either via a corresponding interface to a superordinated unit or to a mobile end device. Another option is, however, not (exclusively) to use the interface as output unit. Thus, a possible display of the fill level measuring device can serve for display of the ascertained pipe inner diameter.

With corresponding design, the fill level measuring device can transmit the two different center frequencies, thus radar signals, for example, with a defined clocking rate alternately in the two different frequency bands, wherein, in such case, the different frequencies of the corresponding intermediate frequency signals are ascertained correspondingly clocked. The further removed the two center frequencies are from one another, the more accurately the pipe inner diameter can be determined. A sufficient accuracy is obtained, when the signal production unit produces the radar signals with corresponding design in such a manner that their center frequencies differ by at least a factor of 1.1, especially a factor of 1.5.

After the initial determining of the pipe inner diameter according to the invention, or when the pipe inner diameter is per se already sufficiently exactly known, the formula

$$D = \frac{{c}_{m , 0} * {k}_{mode}}{π * {f}_{1}} * \sqrt{\frac{{f}_{1}^{2} * {f}_{IF 2}^{2} - {f}_{2}^{2} * {f}_{IF 1}^{2}}{{f}_{2}^{2} * ( {f}_{IF 2}^{2} - {f}_{IF 1}^{2} )}}$$

can, moreover, be used to ascertain the possibly changed free field propagation velocity, and/or a possible change of the gas composition of the atmosphere above the fill substance in the process space. In such case, a possible change of the free field propagation velocity can, for example, be continuously monitored, when the fill level measuring device transmits the radar signals with defined clocking rate alternately in the two different frequency bands.

In order to check the ascertained fill level value, for example, for plausibility, the evaluation unit can be designed to determine the fill level value optionally based on the first intermediate frequency signal, thus its frequency, as well as supplementally based on the second intermediate frequency signal, thus its frequency. When a comparison of the two values results in insufficient agreement, they can be classified as implausible, such that the evaluation unit outputs, for example, a corresponding error signal.

Since within the context of the invention per se the exact value of the pipe inner diameter is determined, the signal producing unit and/or the evaluation unit of the fill level measuring device of the invention can be further developed in that the transmitted radar signals and/or the intermediate frequency signals are subjected to a dispersion correction as a function of the ascertained pipe inner diameter. Dispersion correction is described more exactly in the publication DE 102016105419 A1, for example.

The invention will now be explained in greater detail based on the appended drawing, the figures of which show as follows:

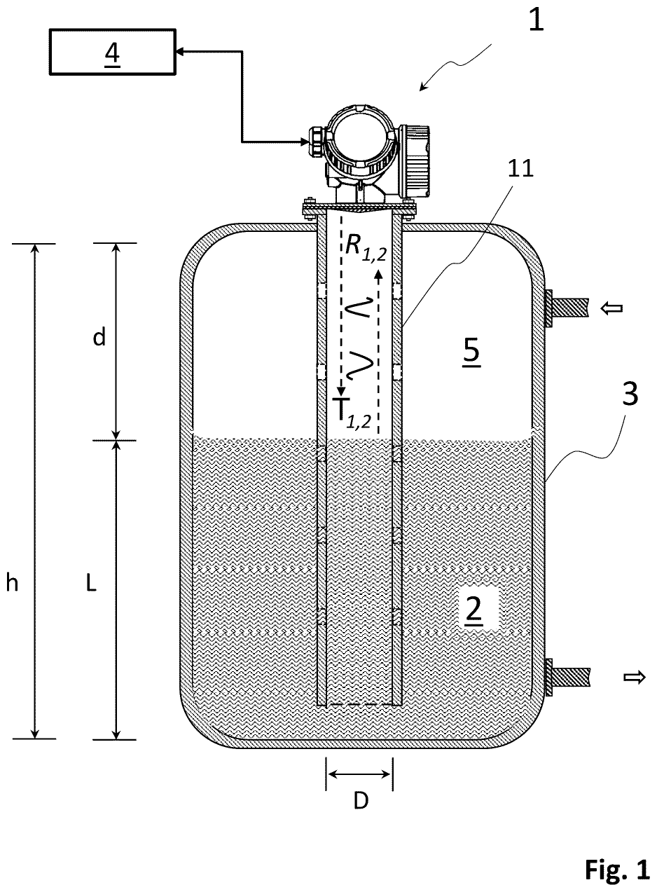

FIG. 1 a typical arrangement of a fill level measuring device working according to the FMCW principle on a surge pipe; and

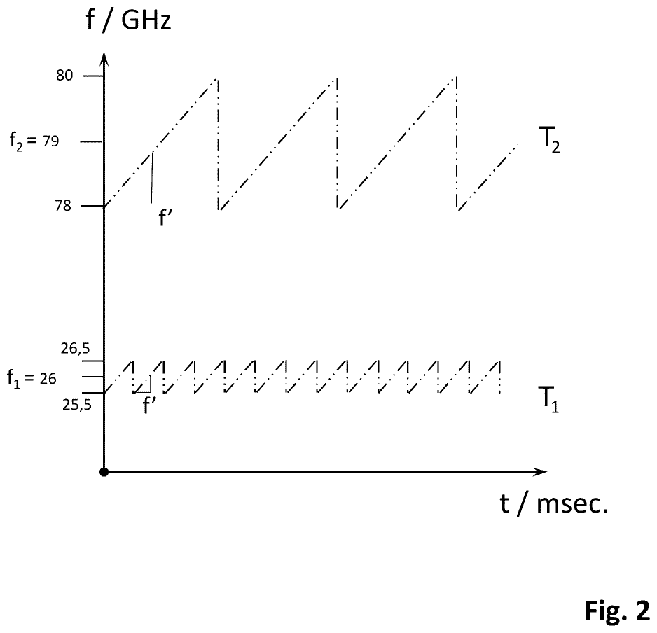

FIG. 2 FMCW radar signal frequency versus time in the context of the invention.

For understanding the invention, FIG. 1 shows a container 3 containing a liquid fill substance 2, whose fill level L is to be determined. In such case, the container 3 can, depending on type of fill substance 2 and depending on field of application, extend to greater than 100 m high. The fill substance 2 can be, for example, water or a fuel, such as crude petroleum or liquefied natural gas.

In order to be able to determine the fill level L, a radar based, fill level measuring device 1 is provided. As a rule, the fill level measuring device 1 is connected via a suitable interface, such as, for example, for example, “4-20 mA”, “PROFIBUS”, “HART” or “Ethernet”, to a superordinated unit 4, such as e.g. a local process-control station or a decentral server system. In this way, the measured fill level values L can be transferred, for example, in order to control possible in- or outgoing flows of the container 3. In this way, however, also other information concerning general operating state of the fill level measuring device 1 can be communicated. When the fill level measuring device 1 transmits to the superordinated unit 4 only the raw measurement data, such as, in the case of the FMCW method, for example, the frequency values f_{1,2} of the intermediate signals IF_{1,2}, the final calculating of the fill level value L based thereon can in the case of corresponding design also occur in the superordinated unit 4.

In order to exclude measurement errors, which can, in principle, arise, for example, as a result of wave formation, the container 3 shown in FIG. 1 includes a surge pipe 11, via which the fill level L is determined. For this, the surge pipe 11 extends from the top of the container 3 approximately perpendicularly downwards into the process space 5 of the container 3. In such case, the length of the surge pipe 11 is so selected that the lower end region of the surge pipe 11 is located at the height corresponding to the minimum fill level value L. In the case of the embodiment shown in FIG. 1, the length of the surge pipe 11 is so selected that its lower end region is located not at the level of the container floor, but, instead, slightly above at the height of a fill substance outlet. In order that the fill level L of the fill substance 2 in the interior of the surge pipe 11 equals the fill level L outside of the surge pipe 11, radially corresponding passageways are provided in the surge pipe 11, distributed over its height.

The fill level measuring device 1 is secured on the upper end region of the surge pipe 11 and comprises, for example, a coupling element or a suitable antenna structure, by means of which the radar signals T_{1,2}, R_{1,2} can be transmitted into the surge pipe 11 in the container 3 and after reflection on the fill substance surface out-coupled from the surge pipe 11.

After reflection of the transmitted radar signal T_{1,2} on the fill substance surface, the fill level measuring device 1 receives the reflected radar signals R_{HF}, in turn, via its coupling element. In such case, the resulting signal travel time t between transmitting and receiving the radar signal THF, R_{HF} is according to

$$t = \frac{2 * d}{{c}_{m} ( D )} \qquad ( 1 )$$

proportional to the distance d between the fill level measuring device 1 and the surface of the fill substance 2. The variable “cₘ(D)” is, in this connection, the media- and pipe inner diameter-dependent, radar propagation velocity, which differs differently greatly from the free field radar propagation velocity c_{m,0}, depending on pipe inner diameter D. In such case, the radar propagation velocity in the free field c_{m,0} depends, in turn, on the gas composition and those properties, which influence the propagation velocity of the radar signals T_{1,2}, R_{1,2} before and after the reflection.

In order to determine the signal travel time t, the FMCW principle is implemented in the fill level measuring device 1. Accordingly, the fill level measuring device 1 can comprise as signal production unit, for example, a phase control loop (“phase locked loop”). Such is so controlled that the frequency of the transmitted radar signal T_{1,2} changes with sawtooth shape, such as shown in FIG. 2. As can be seen, the frequency f of the radar signal T_{1,2} has within a defined frequency band (for example, 79 GHZ-80 GHz or 25.5 GHz-26.5 GHZ) a cyclically recurring, constant frequency increase rate f′. Instead of a sawtooth shaped frequency change rate f′, any other shape can be used, for example, a triangular or sinusoidal change within the frequency band. That frequency f_{1,2}, which forms the arithmetic average value between the upper and lower limits of the frequency band, is referred to, in such case, as the center frequency f_{1,2}.

After receipt from the surge pipe 11, the reflected radar signal R_{1,2} is mixed within the fill level measuring device 1 according to the FMCW principle with the transmitted radar signal T_{1,2}, whereby a corresponding intermediate frequency signal IF_{1,2} is generated. In such case, the frequency f_{IF1,2} of the intermediate frequency signal IF_{1,2} yields according to

$$t = \frac{{f}_{IF 1 , 2}}{{f}^{′}} \qquad ( 2 )$$

the signal travel time t of the radar signal S_{1,2}, R_{1,2} between transmission and receipt. In such case, f′ is the frequency change rate of the radar signals. In order to determine the frequency f_{IF1,2} of the intermediate frequency signal IF_{1,2} and, thus, the signal travel time t, for example, a Fast-Fourier transformation of the intermediate frequency signal IF_{1,2} can be performed in an evaluation unit of the fill level measuring device 1. As usual in the processing of such data, this happens, as a rule, based on a digitized intermediate frequency signal IF_{1,2}.

By determining the signal travel time t, the evaluation unit can calculate the distance d using formula (1). The fill level measuring device 1 can then determine the fill level L, at least pointwise, using

$$d = h - L \qquad ( 3 )$$

when the installed height h of the fill level measuring device 1 over the container floor, or the minimum fill level, is known. In the case of a container 3 known to be empty, a determining of the installed height h can be done by the fill level measuring device 1 itself. Such can occur e.g. in the context of a learning-procedure, in that, analogously to a measurement of fill level L, the distance h of the fill level measuring device 1 from the container-floor is measured.

As can be seen from formula (1), it is necessary to know the signal propagation-velocity cₘ(D) of the transmitted radar signals T_{1,2}, R_{1,2} in the surge pipe 11. For this, according to

$${c}_{m} ( D ) = {c}_{m , 0} * \sqrt{1 - {( \frac{{k}_{m o d e}^{2} * {c}_{m , 0}}{π * {f}_{1 , 2} * D} )}^{2}} \qquad ( 4 )$$

besides the radar propagation velocity c_{m,0} in the free field, also knowledge of the pipe inner diameter D is required. In the case of k_{mode}, involved is a mode-dependent constant, which comes from the Bessel-function and is, thus, known.

It is true that the pipe inner diameter D of the surge pipe 11 is, as a rule, nominally known, for example, when a DN100-pipe is involved. In particular, the exact, or true, value is however, not known. It can differ noticeably from the desired value. The result is that the fill level measuring device 1 cannot determine the fill level L exactly, since the fill level measuring device 1, and particularly its evaluation unit, need the correct value of the pipe inner diameter D for fill level-calculating according to the formulas (1) to (3).

With the help of the method of the invention it is possible, even without knowledge of the approximate, or nominal, diameter, exactly to ascertain the pipe inner diameter D of the surge pipe 11. Based on the ascertained pipe inner diameter D, the fill level measuring device 1 is, in turn, enabled, based on the pipe inner diameter D, correspondingly to calibrate, or to ascertain the signal propagation-velocity cₘ(D) in the surge pipe 11, in order in subsequent, regular measurement operation to be able to determine the fill level L exactly using the formulas (1) and (2). For this, the fill level measuring device 1 transmits, according to the FMCW principle, radar signals T₁, T₂ not in only a first frequency band, having a first center frequency f₁, but, instead, also in a second frequency band, having a second center frequency f₂. Correspondingly for this, the evaluation unit of the fill level measuring device 1 of the invention ascertains, such as above explained in connection with the FMCW principle, for each frequency band, and each center frequency f₁, f₂, a corresponding intermediate frequency signal IF₁, IF₂ and its frequency f_{IF1}, f_{IF2}. When the signal production unit produces the two transmitted radar signals T₁, T₂, in spite of the different frequency bands with the same frequency change rate f′, the pipe inner diameter D can be ascertained by the evaluation unit or the superordinated unit 4 according to

$$D = \frac{{c}_{m , 0} * {k}_{mode}}{π * {f}_{1}} * \sqrt{\frac{{f}_{1}^{2} * {f}_{IF 2}^{2} - {f}_{2}^{2} * {f}_{IF 1}^{2}}{{f}_{2}^{2} * ( {f}_{IF 2}^{2} - {f}_{IF 1}^{2} )}} \qquad ( 5 )$$

In such case, f₁, f₂ are the center frequencies of the two different frequency bands. In the case of f_{IF1}, f_{IF2}, these are the frequencies of the corresponding intermediate frequency signals IF₁, IF₂.

When the frequency change rates f′_{1,2} of the two transmitted radar signals T₁, T₂ are not identical, formula (5) is modified to formula (6)

$$D = \frac{{c}_{m , 0} * {k}_{mode}}{π * {f}_{1}} * \sqrt{\frac{{f}_{1}^{2} * {f}_{IF 2}^{2} * {f}_{1}^{′2} - {f}_{2}^{2} * {f}_{IF 1}^{2} * {f}_{2}^{′2}}{{f}_{2}^{2} * ( {f}_{IF 2}^{2} * {f}_{1}^{′2} - {f}_{IF 1}^{2} * {f}_{2}^{′2} )}} \qquad ( 6 )$$

The idea of the invention can be implemented, for example, in that the signal production unit transmits the two frequency bands, thus the radar signals T₁, T₂, for example, clocked, such that the radar signals T₁, T₂ are transmitted correspondingly with clock alternating center frequencies f₁, f₂. Correspondingly clocked are the different received signals R₁, R₂ received after reflection on a shared reference and the different frequencies f_{IF1}, f_{IF2} of the resulting intermediate frequency signals IF₁, IF₂ ascertained. In such case, it is within the scope of the invention conceivable that the two frequency bands overlap, as long as their limits are not identical and accordingly their center frequencies f₁, f₂ differ from one another. In the case of the example shown in FIG. 2, the center frequencies f₁, f₂ lie with 26 GHz and 79 GHz apart about by a factor of 3. Within the scope of the invention, it is sufficient, however, that the center frequencies f₁, f₂ differ at least by a factor of 1.1. In principle, the following holds in such case: the greater the two center frequencies f₁, f₂ differ from one another, the greater is the difference in the intermediate frequencies f_{IF1}, f_{IF2} and the more accurately the pipe inner diameter can be determined.

Since the calculating of the pipe inner diameter per the invention according to formula (5), or formula (6) is only valid when the radar signals T₁, T₂ transmitted in the different frequency bands reflect on one and the same reference, the circumstances, under which the two transmitted radar signals T₁, T₂ are transmitted in the different frequency bands, are to be selected correspondingly: defined as shared, locationally fixed 9 reference can be in the simple case the lower end region of the surge pipe 11 when such end region has, for example, a slightly inwardly turned collar, which enables an effective reflection of the radar signals T₁, T₂. When the lower end region of the surge pipe 11 is located radar near to the floor of the container interior, the floor can also serve in the context of the method of the invention as shared reference for reflection of the radar signals T_{1,2}, R_{1,2}. When at that point in time, when the frequency band of the transmitted radar signal T₁, T₂ is changed for the purpose of determining the pipe inner diameter according to the invention, the fill level L does not change, also the fill 17 substance surface can be used as shared reference.

When, or with which clock rate, the fill level measuring device 1 switches between the frequency bands, in order to determine the pipe inner diameter D (anew), can be adapted to the particular application. For example, the fill level measuring device 1 of the invention can be so designed that it switches the frequency band only upon request, or corresponding input, and the fill level measuring device 1 updates the pipe inner diameter D accordingly only after corresponding request.

Another option is, however, also that the fill level measuring device 1 of the invention is designed automatically to change between the frequency bands with a predeterminable clocking rate. In such case, the corresponding two time periods within the rhythm, with which the fill level measuring device transmits the radar signal T₁, T₂ in the frequency bands with the different center frequencies f₁, f₂, do not need to be symmetrical. In this case, the pipe inner diameter D is recalculated by means of the method of the invention only with the corresponding clocking rate, when it is assured that at such point in time the radar signals T₁, T₂ of the two frequency bands are reflected on the same reference. Between the clocked alternating of the frequency bands, thus, for example, when the radar signal T₁ is being transmitted within the first frequency band with the first center frequency f₁, the fill level L is ascertained based on the frequency f_{IF1} of the corresponding, first intermediate frequency signal IF₁. In such case, it is within the scope of the invention not important which of the two frequencies f_{IF1,2} of the two intermediate frequency signals IF₁, IF₂ the fill level measuring device 1 uses to determine the fill level value L. Another option in this connection is that the fill level measuring device 1, in each case, ascertains fill level value L based on the two frequencies f_{IF1,2}, thus two intermediate frequency signals IF₁, IF₂, and compares the two values with one another, in given cases, for the purpose of a plausibility check. An option is, moreover, that the fill level measuring device 1, after determining the pipe inner diameter D according to the invention, determines the fill level L based on a third radar signal and its third intermediate frequency.

The possible clocking rate, with which changing between the two radar signal frequency bands occurs for pipe inner diameter determination, can, depending on application, amount, for example, to one month, when no change of the pipe inner diameter D is to be expected in the intervening time. In a case when a faster change is to be expected, as, for example, in the case of accretion formation, the clocking rate in the fill level measuring device 1 can also be set to one day or shorter.

When the fill level measuring device 1 has an optical output unit, such as a display and the pipe inner diameter D is not calculated in the superordinated unit 4, it is in the case of corresponding design of the fill level measuring device 1 additionally possible that the ascertained pipe inner diameter D is, in such case, displayed. On the whole, it is assured by the determining of pipe inner diameter D according to the invention that the fill level measuring device 1, or the superordinated unit 4, calculates the fill level value L, at any time, based on the correct signal propagation velocity cₘ(D) in the surge pipe 11.

### LIST OF REFERENCE CHARACTERS AND VARIABLES

1 fill level measuring device
2 fill substance
3 container
4 superordinated unit
5 process space
11 surge pipe
c_{m,0} radar propagation velocity in free field
cₘ(D) signal propagation velocity in the surge pipe
D pipe inner diameter
d distance to the fill substance
R_{1,2} reflected radar signals
f′ frequency change rate of the radar signals
f_{1,2} center frequencies of the radar signals
f_{IF1,2} frequencies of the intermediate frequency signals
h installed height of the fill level measuring device
k_{mode} mode-dependent constant
L fill level
T_{1,2} radar signals
IF_{1,2} intermediate frequency signals

What is claimed is:

1-12. (canceled)

13. A method for determining a pipe inner diameter of a surge pipe, which, for measuring fill level of a fill substance located in a process space of a container, extends into the process space or is mounted alongside the container and connected with the process space, the method comprising:
transmitting a first radar signal according to an FMCW principle with a first center frequency into the surge pipe and receiving a corresponding first received signal after reflection on a locationally fixed reference;
generating a first intermediate frequency signal according to the FMCW principle based on the first transmitted signal and the first received signal and ascertaining a frequency of the first intermediate frequency signal;
transmitting a second radar signal according to the FMCW principle into the surge pipe with a second center frequency, which differs from the first center frequency, and receiving a corresponding second received signal after reflection on the locationally fixed reference;
generating a second intermediate frequency signal according to the FMCW principle based on the second transmitted signal and the second received signal and ascertaining a frequency of the second intermediate frequency signal;
ascertaining the pipe inner diameter based on: the first center frequency, the second center frequency, the frequency of the intermediate frequency signal, and the frequency of the second intermediate frequency signal.

14. The method as claimed in claim 13, wherein the locationally fixed reference is the surface of the fill substance, a lower end region of the surge pipe, or a floor of the container.

15. The method as claimed in claim 13, wherein the first and second radar signals are transmitted with an equal frequency change rate.

16. The method as claimed in claim 15, wherein using:
$$D = \frac{{c}_{m , 0} * {k}_{mode}}{π * {f}_{1}} * \sqrt{\frac{{f}_{1}^{2} * {f}_{IF 2}^{2} - {f}_{2}^{2} * {f}_{IF 1}^{2}}{{f}_{2}^{2} * ( {f}_{IF 2}^{2} - {f}_{IF 1}^{2} )}}$$
the pipe inner diameter, or, in the case of a known pipe inner diameter, a free field propagation velocity of the radar signals is ascertained.

17. The method as claimed in claim 16, wherein the signal propagation velocity in the surge pipe is determined or, based thereon, the fill level is determined, based on the ascertained pipe inner diameter, as well as based on the frequency of at least one of the intermediate frequency signals or a frequency of a third intermediate frequency signal.

18. A fill level measuring device for performing the method as claimed in claim 17, comprising:
a signal production unit for FMCW-based production of the first radar signal and the second radar signal;
a coupling element by which the first radar signal and the second radar signal are coupleable into the surge pipe and by which the first received signal and the second received signal are coupleable out of the surge pipe after their reflection;
a mixer unit for mixing the transmitted radar signals with the matching received signal such that the corresponding intermediate frequency signals are generated according to the FMCW principle;
an evaluation unit that is designed to ascertain the frequencies of the intermediate frequency signals, to determine the pipe inner diameter based on the center frequencies and the frequencies of the intermediate frequency signals, and, based on the ascertained pipe inner diameter as well as the frequency of at least one of the intermediate frequency signals or the frequency of a third intermediate frequency signal, to determine the signal propagation velocity in the surge pipe, and, based thereon, the fill level.

19. The fill level measuring device as claimed in claim 18 and designed to transmit the radar signals with the two different center frequencies alternately and with a defined clocking rate and to ascertain, correspondingly clocked, the different frequencies of the corresponding intermediate frequency signals.

20. The fill level measuring device as claimed in claim 19 and designed to ascertain a free field propagation velocity and/or a possible change of a gas composition of an atmosphere above the fill substance in the process space.

21. The fill level measuring device as claimed in claim 18, further comprising:
an output unit serving for display of the pipe inner diameter.

22. The fill level measuring device as claimed in claim 21, wherein the signal production unit is designed to produce the radar signals in such a manner that their center frequencies differ at least by a factor of 1.1.

23. The fill level measuring device as claimed in claim 22, wherein the evaluation unit is designed to determine the fill level based on the first intermediate frequency signal, thus its frequency, and based on the second intermediate frequency signal, thus its frequency.

24. The fill level measuring device as claimed in one of claim 23, wherein the signal producing unit and/or the evaluation unit is/are designed to subject the transmitted radar signals and/or the intermediate frequency signals to a dispersion correction as a function of the ascertained pipe inner diameter.
